(19) United States
(12) Patent Application Publication
(10) Pub. No.: US 2024/0253258 A1
(43) Pub. Date: Aug. 1, 2024

(54) VARIABLE LENGTH GRIPPER ASSEMBLY FOR A FOOD SLICING MACHINE AND METHOD OF OPERATING SAME

(71) Applicant: Provisur Technologies, Inc., Chicago, IL (US)

(72) Inventor: Michael Severns, Naperville, IL (US)

(73) Assignee: Provisur Technologies, Inc., Chicago, IL (US)

(21) Appl. No.: 18/417,416

(22) Filed: Jan. 19, 2024

Related U.S. Application Data
(60) Provisional application No. 63/482,098, filed on Jan. 30, 2023.

(51) Int. Cl. B26D 7/01

(52) U.S. Cl. CPC B26D 7/01; B26D 2007/011; B26D 2210/02

(57) ABSTRACT

A gripper for gripping a rear end of the food product includes a jaw mounting body having a pneumatic pathway therethrough, a pair of jaws pivotally mounted thereon, a moving assembly which moves the pair of jaws from an open position to a closed position, a controller, and a contact plate assembly which provides information regarding a pressure spike in the pneumatic pathway to the controller that contact with the rear end of the food product has occurred. Multiple ones of the grippers can be provided as part of a food product slicing machine. A method of using same is also provided.

### CROSS-REFERENCE TO RELATED APPLICATION

This application claims priority to U.S. provisional Application No. 63/482,098 filed Jan. 30, 2023, the contents of which are incorporated herein in its entirety.

### FIELD OF THE DISCLOSURE

The present disclosure generally relates to a gripper assembly for gripping products to be sliced by a slicing machine, and the slicing machine. A method of using the gripper assembly is also provided.

### BACKGROUND

Food product slicing machines have existed for some time and are used to slice various food products at a high speed rate. Exemplary food products include meat, such as beef, chicken, fish, pork, etc., and cheese. Various deficiencies have been identified with such food product slicing machines.

Prior art food product slicing machines may include a product gate that holds back a food product (typically a large block of food product having a relatively significant weight) and a gripper that grips a rear of the food product. When the food product gate is lowered, the gripper retains the food product and preventing the food product from moving forward toward a slicing station where the food product is ultimately sliced by a blade.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a schematic view of a food product slicing machine including a gripper assembly in accordance with the present disclosure and with a product gate in a first position;

FIG. 2 depicts a schematic view of the food product slicing machine including the gripper assembly in accordance with the present disclosure and with a product gate in a second position;

FIG. 3 depicts a top perspective view of a gripper of the gripper assembly with jaws of the gripper in an open position;

FIG. 4 depicts a side elevation view of the gripper of FIG. 3;

FIG. 5 depicts a bottom plan view of the gripper of FIG. 3;

FIG. 6 depicts a top perspective view of a gripper of the gripper assembly with jaws of the gripper in a closed position;

FIG. 7 depicts a side elevation view of the gripper of FIG. 6;

FIG. 8 depicts a bottom plan view of the gripper of FIG. 6;

FIG. 9 depicts a cross-sectional view of the gripper along line 9-9 of FIG. 5;

FIG. 9A depicts an enlargement of a portion of FIG. 9;

FIG. 9B depicts an enlargement of a portion of FIG. 9;

FIG. 10 depicts a cross-sectional view of the gripper along a portion of line 10-10 of FIG. 5;

FIG. 11 depicts a cross-sectional view of the gripper along a portion of line 11-11 of FIG. 5;

FIG. 12 depicts a cross-sectional view of the gripper along line 12-12 of FIG. 4;

FIG. 12A depicts an enlargement of a portion of FIG. 12;

FIG. 13 depicts a cross-sectional view of the gripper similar to FIG. 9, but with a contact plate assembly in a moved position;

FIG. 14 depicts a cross-sectional view of the gripper similar to FIG. 12, but with the contact plate assembly in a moved position;

FIG. 15 depicts a cross-sectional view of the gripper similar to FIG. 13, but with a connecting rod in a moved position;

FIG. 16 depicts a cross-sectional view of the gripper along line 16-16 of FIG. 8, which is similar to FIG. 13, but with the jaws closed and a piston in a moved position;

FIG. 17 depicts a cross-sectional view of the gripper along line 17-17 of FIG. 7, which is similar to FIG. 14, but with the jaws closed and a piston in a moved position;

FIGS. 18-25 depict top plan views showing the method of gripping rear ends of food products using the grippers;

FIGS. 26 and 27 depict bottom perspective views of butt ends of the food products being disposed of through an opening; and

FIG. 28 depicts a schematic view of the food product slicing machine as part of a line of food processing equipment.

### DETAILED DESCRIPTION

While the disclosure may be susceptible to embodiment in different forms, there is shown in the drawings, and herein will be described in detail, a specific embodiment with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

A variable length gripper assembly 20 for a food product slicing machine 22 is provided. With reference to the figures, one example of a food product slicing machine 22 is shown. The food product slicing machine 22 is used to slice food products 24a, 24b, 24c, 24d into slices. The food products 24a, 24b, 24c, 24d may be comprised of a wide variety of edible materials including, but not limited to meat, such as beef, chicken, fish, pork, etc., and cheese. The food products 24a, 24b, 24c, 24d may be unfrozen, frozen, or crust frozen. The food products 24a, 24b, 24c, 24d may have different lengths, and the variable length gripper assembly 20 grips a rear end of each food product 24a, 24b, 24c, 24d while maintaining a front end of each food product 24a, 24b, 24c, 24d in an aligned arrangement.

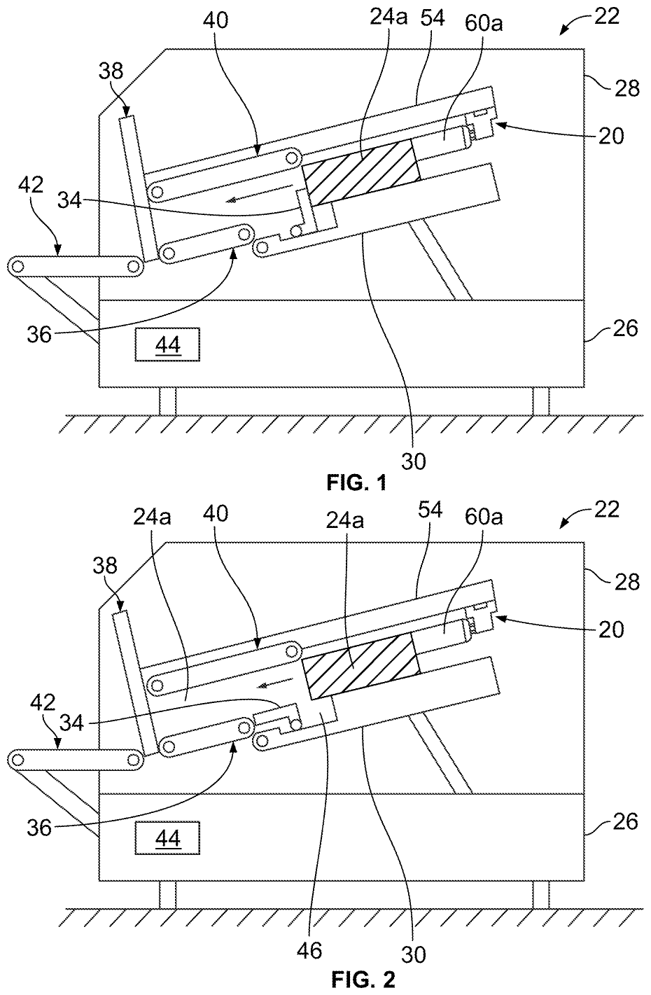

As shown in FIGS. 1 and 2, the food product slicing machine 22 includes a base 26 which supports the food product slicing machine 22 on the ground and a frame 28 on the base 26. The frame 28 supports a tray 30 which receives the food products 24a, 24b, 24c, 24d which are being sliced thereon, a product gate 34 against which the forward end of the food products 24a, 24b, 24c, 24d bear against, the gripper assembly 20 which is above the tray 30, a lower support assembly 36 which receives the food products 24a, 24b, 24c, 24d from the tray 30, and a shear edge and slicing assembly 38 which receives the food products 24a, 24b, 24c, 24d from the lower support assembly 36 and slices the food products 24a, 24b, 24c, 24d into slices. In some embodiments, an upper support assembly 40 is provided above the lower support assembly 36. An output portion 42 receives the slices from the shear edge and slicing assembly 38. The output portion 42 may be mounted on the base 26 and/or frame 28, or may be a separate component. The base 26 supports the other components on a ground surface and includes various mechanisms and power systems for powering the food product slicing machine 22. A control system 44 is provided and is configured to control operation of the food product slicing machine 22. The control system 44 may be mounted on the base 26, on the frame 28 or may be remote from the food product slicing machine 22. The control system 44 includes all the necessary hardware and software to perform all of the operations and functions of the food product slicing machine 22. The food product slicing machine 22 forms a component in a slicing line that includes other machines/apparatuses that process food products.

The tray 30 may be a driven endless belt or may be a non-driven plate. Planar upper surfaces of the tray 30 are aligned with planar upper surfaces of the lower support assembly 36 when slicing is being performed.

The product gate 34 may be on the tray 30 or may be on the frame 28. When the tray 30 is in the inclined position, the product gate 34 is upright so that ends of the food products 24a, 24b, 24c, 24d can bear thereagainst. When the tray 30 is in the inclined position, and after the food products 24a, 24b, 24c, 24d are gripped by the gripping assembly 20 as described herein, the product gate 34 is moved to a down position and a gap 46, see FIGS. 2, 26, and 27, is formed between the tray 30 and the product gate 34.

The lower support assembly 36 may be endless driven belt which defines a surface, which may be tactile, along which food products 24a, 24b, 24c, 24d will translate or may be a non-movable tray. In use, the lower support assembly 36 receives the food products 24a, 24b, 24c, 24d from the tray 30 after the food products 24a, 24b, 24c, 24d pass over the lowered product gate 34. The food products 24a, 24b, 24c, 24d translate along an upper surface of the lower support assembly 36. The type of lower support assembly 36 is dependent upon the type of food product being sliced.

The upper support assembly 40, if provided, may be endless driven belt which defines a surface, which may be tactile, along which food products 24a, 24b, 24c, 24d will translate or may be a non-movable tray. The type of upper support assembly 40 is dependent upon the type of food product being sliced. In use, the support assemblies 36, 40 receive the food products 24a, 24b, 24c, 24d from the tray 30 after passing over the lowered product gate 34. The food products 24a, 24b, 24c, 24d translate between the support assemblies 36, 40, along an upper surface of the lower support assembly 36 and along a lower surface of upper support assembly 40.

The shear edge and slicing assembly 38 is conventional and the specifics are not described herein. The shear edge and slicing assembly 38 includes a blade which rotates relative to a shear bar defining the shear edge to slice the food products 24a, 24b, 24c, 24d into individual slices.

After being sliced by the shear edge and slicing assembly 38, the sliced food product is supported on the output portion 42 of the food product slicing machine 22 in stacks or in shingles and is moved away from the shear edge and slicing assembly 38 by the output portion 42. The output portion 42 may be conveyor.

The gripper assembly 20 is movable relative to the frame 28 and relative to the lower support assembly 36 and to the upper support assembly 40, if provided. In the embodiment as shown, see FIG. 18, the gripper assembly 20 includes parallel first and second side rails 52, 54 mounted on the frame 28, a first gripper support rail 56 extending from the first side rail 52 toward the second side rail 54, a second gripper support rail 58 extending from the second side rail 54 toward the first side rail 52, first and second grippers 60a, 60b mounted on the first gripper support rail 56, and third and fourth grippers 60c, 60d mounted on the second gripper support rail 58. While four grippers 60a, 60b, 60c, 60d are shown and described herein, two or more grippers can be provided.

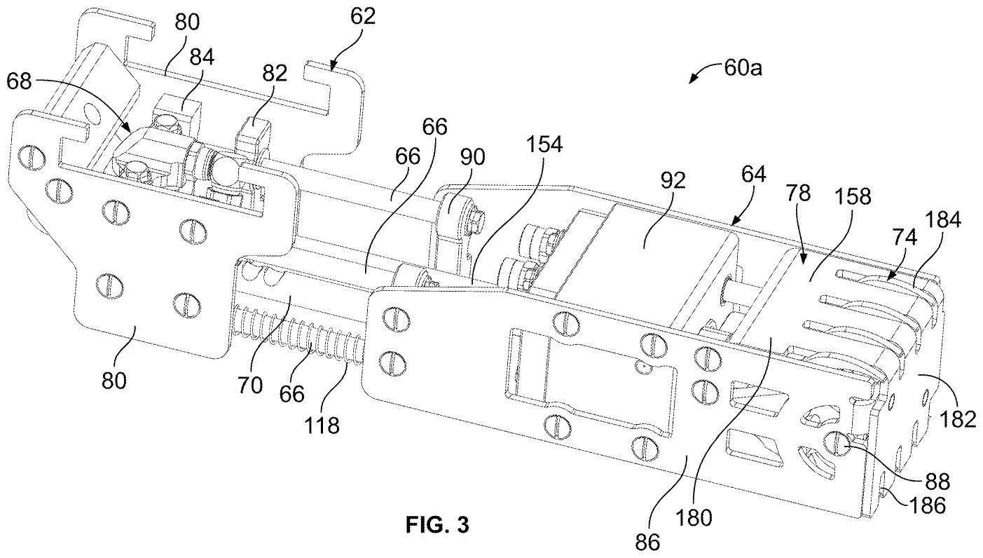

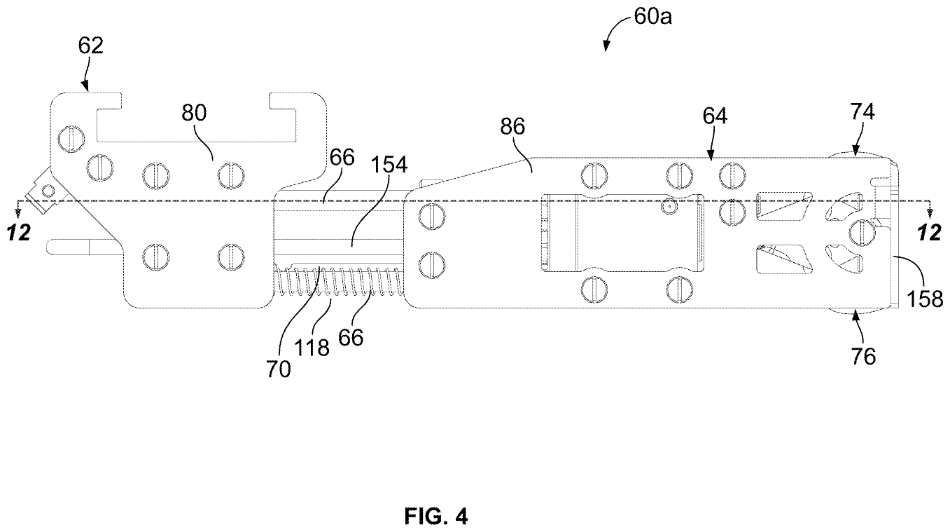

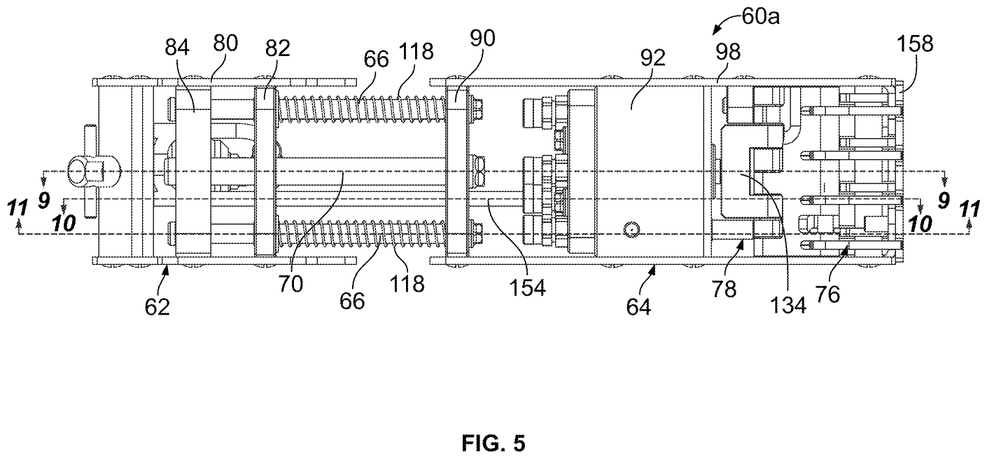

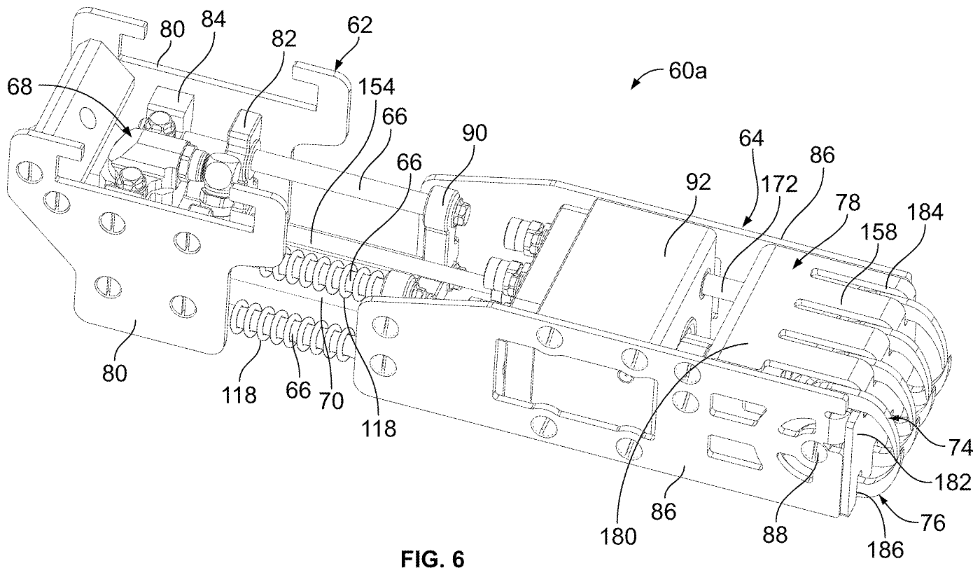

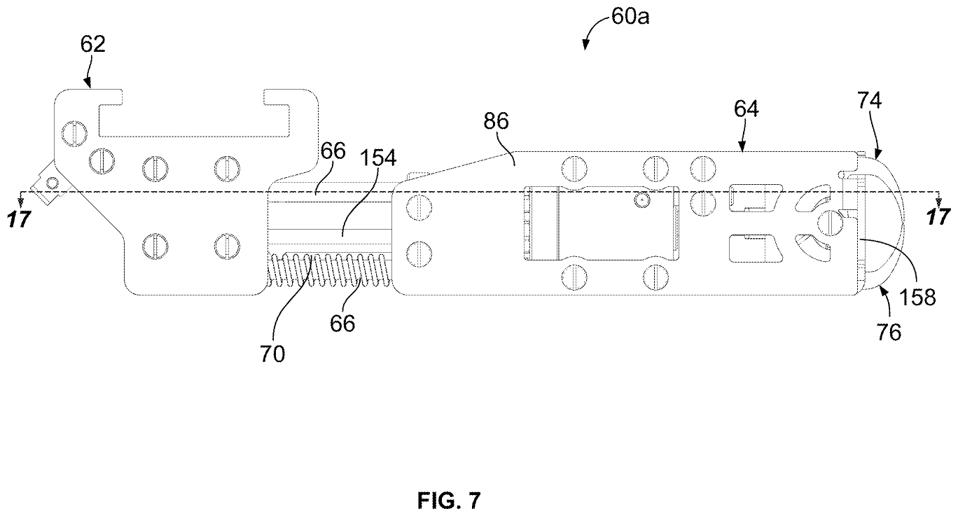

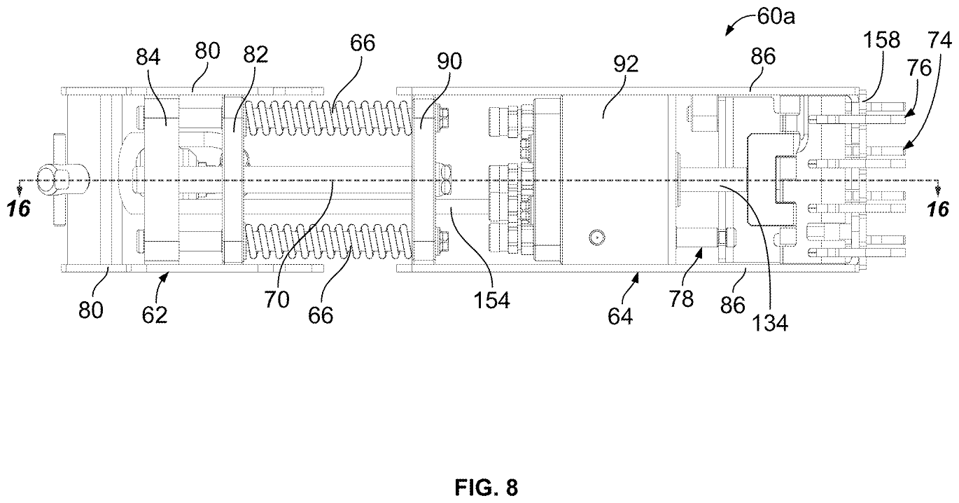

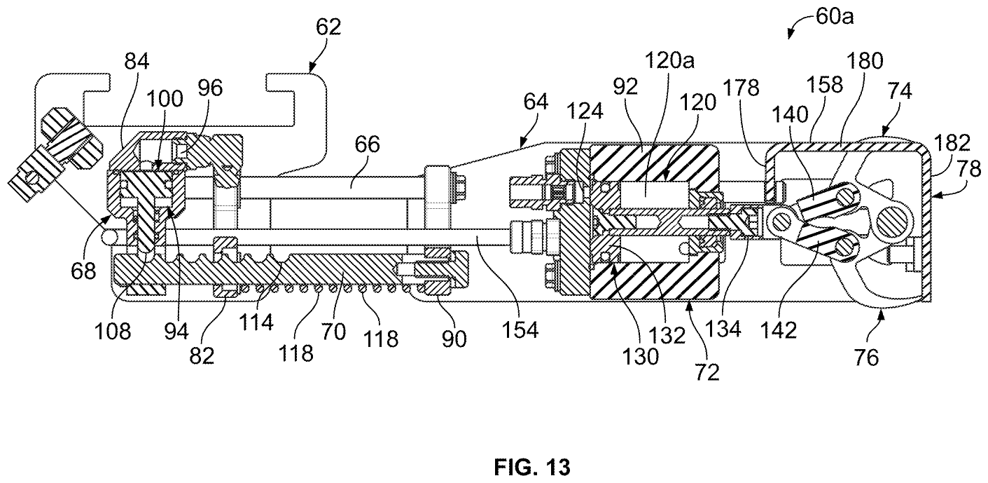

Each gripper 60a, 60b, 60b, 60d is identically formed and for clarity, only gripper 60a is described, and is shown in FIGS. 3-17 in detail.

The gripper 60a includes a locking body 62, a jaw mounting body 64 coupled to the locking body 62 by a plurality of support rods 66, a piston assembly 68 coupled to the locking body 62, a connecting rod 70 coupled between the jaw mounting body 64 and the piston assembly 68, a piston assembly 72 coupled to the jaw mounting body 64, upper and lower jaws 74, 76 pivotally mounted to the jaw mounting body 64 by the piston assembly 72, and a contact plate assembly 78 coupled to the jaw mounting body 64.

The locking body 62 includes first and second side plates 80, a front support plate 82 extending between front ends of the side plates 80, and a rear body portion 84 extending between rear ends of the side plates 80. The side plates 80 are parallel to each other.

The jaw mounting body 64 includes first and second side plates 86, a front cylindrical rod 88 extending between the side plates 86, a rear support plate 90 extending between rear end of the side plates 86, and an intermediate body portion 92 extending between the side plates 86. The intermediate body portion 92 is between the front cylindrical rod 88 and the rear support plate 90. The side plates 86 are parallel to each other.

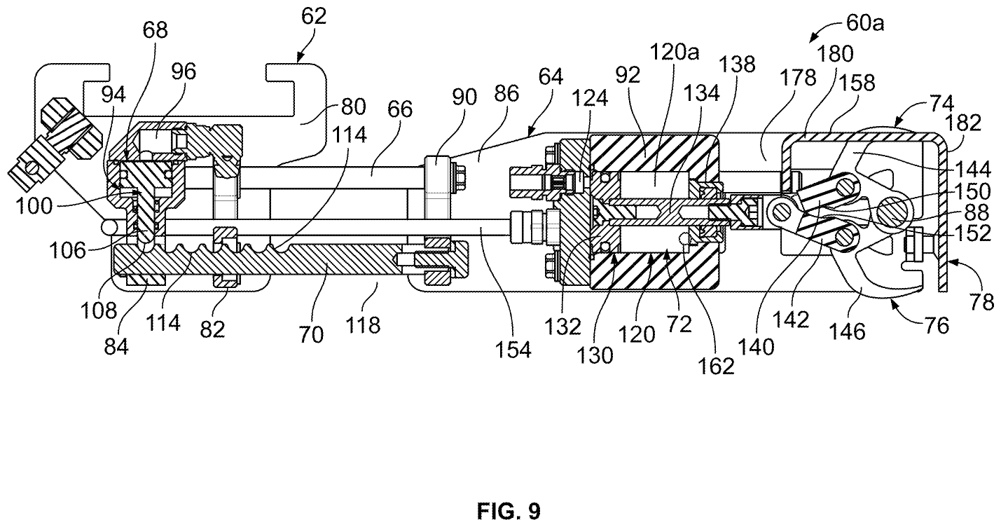

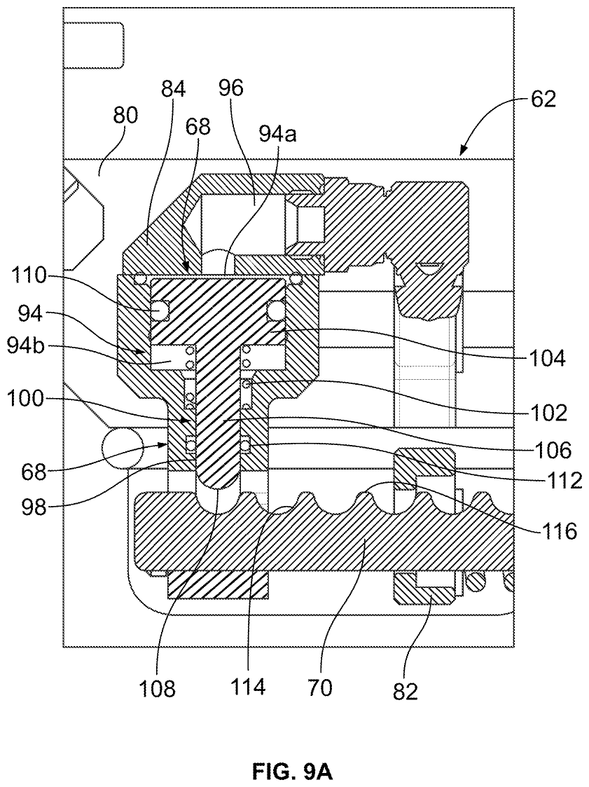

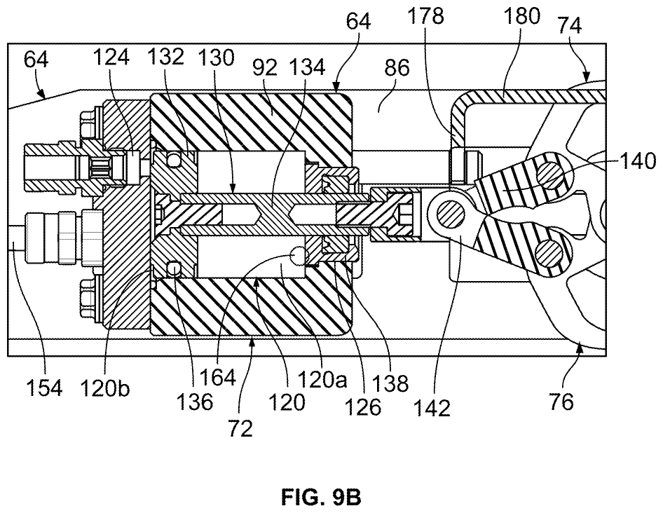

As shown in FIGS. 9 and 9A, the piston assembly 68 includes a pneumatic chamber 94 formed within the rear body portion 84, a gases passageway 96 extending from the exterior of the rear body portion 84 and into an upper end of the pneumatic chamber 94, a passage 98 extending from a lower end of the pneumatic chamber 94 to a lower end of the rear body portion 84, a piston 100 mounted within the pneumatic chamber 94 and the passage 98, and a return spring 102 within the pneumatic chamber 94 and engaged with the piston 100. The passage 98 has a diameter which is less than the diameter of the pneumatic chamber 94.

The piston 100 includes an enlarged head 104 and a piston rod 106 extending from a first side of the enlarged head 104. The piston rod 106 has a lower rounded end 108. The enlarged head 104 is within the pneumatic chamber 94, and a seal 110, which may be provided by an O-ring, surrounds the head 104 and separates the pneumatic chamber 94 into an upper chamber portion 94a and a lower chamber portion 94b. The upper chamber portion 94a is in gases communication with the gases passageway 96 and the lower chamber portion 94b is in communication with the passage 98. The piston rod 106 extends through the lower chamber portion 94b and the passage 98, and further extends downward and outward from the rear body portion 84. The return spring 102 surrounds the piston rod 106 and has a lower end engaged against a wall of the passage 98 and an upper end engaged against a lower surface of the enlarged head 104. A seal 112, which may be provided by an O-ring, surrounds the piston rod 106 below the return spring 102 to prevent intrusion of debris/water through the passage 98.

The connecting rod 70 is affixed to and extends rearward from the rear support plate 90 of the jaw mounting body 64, extends through the front support plate 82 of the locking body 62, through the rear body portion 84 of the locking body 62, and extends below the bottom end 108 of the piston rod 106. The connecting rod 70 has a plurality of adjacent pockets 114 provided along the length thereof, which start at the free end of the connecting rod 70. The pockets 114 are sized to conform to the shape of the bottom end 108 of the piston rod 106. Adjacent pockets 114 are separated by walls 116; each wall 116 having a curved upper surface.

The support rods 66 extend through the rear support 90 of the jaw mounting body 64, extend through the front support plate 82 of the locking body 62, and extend through the rear body portion 84 of the locking body 62. As shown, four support rods 66 are provided with two each in a stacked configuration proximate to each side plate 80. Two or more of the support rods 66 have return springs 118 surrounding the support rods 66 and which extend between the front support plate 82 of the locking body 62 and the rear support plate 90 of the jaw mounting body 64.

When the upper chamber portion 94a is pressurized as described herein, the piston 100 moves downwardly and compresses the return spring 102. The bottom end 108 of the piston rod 106 seats within the pocket 114 of the connecting rod 70 that is positioned therebelow. If a wall 116 is positioned under the bottom end 108 of the piston rod 106 when the piston 100 is moved downward, the bottom end 108 will slide along the upper surface of the wall 116 and into one of the pockets 114. When the bottom end 108 of the piston rod 106 is positioned within one of the pockets 114 and the upper chamber portion 94a is pressurized, the connecting rod 70, and thus the jaw mounting body 64 and the components thereon, cannot move relative to the locking body 62. When the pressure in the upper chamber portion 94a is relieved, the return spring 102 expands to cause the piston 100 to move upward. This moves the bottom end 108 of the piston rod 106 out of the pocket 114 to allow for movement of the connecting rod 70 relative to the locking body 62, thereby allowing for movement of the jaw mounting body 64 and the components thereon relative to the locking body 62.

As shown in FIGS. 9, 9B, 11-12A, the piston assembly 72 includes a pneumatic chamber 120 formed within the intermediate body portion 92, a gases passageway 122 extending from the exterior of the intermediate body portion 92 and into a front end of the pneumatic chamber 120, a gases passageway 124 extending from the exterior of the intermediate body portion 92 and into a rear end of the pneumatic chamber 120, a passage 126 extending from a front end of the pneumatic chamber 120 to a front end of the intermediate body portion 92, a gases passageway 128 extending from the exterior of the intermediate body portion 92 and into the rear end of the pneumatic chamber 120, and a piston 130 mounted within the pneumatic chamber 120 and the passage 126. The passage 126 has a diameter which is less than the diameter of the pneumatic chamber 120.

The piston 130 includes an enlarged head 132 and a piston rod 134 extending from a first side of the enlarged head 132. The enlarged head 132 is within the pneumatic chamber 120 and a seal 136, such as an O-ring, surrounds the head 132 and separates the pneumatic chamber 120 into a front chamber portion 120a on the first side of the head 132 and a rear chamber portion 120b on the second side of the head 132. The front chamber portion 120a is in communication with the passage 126 and in gases communication with the gases passageway 122. The rear chamber portion 120b is in gases communication with the gases passageways 124, 128. The piston rod 134 extends through the front chamber portion 120a and the passage 126, and further extends outward and forward from the intermediate body portion 92. A seal 138 is provided between the piston rod 134 and the wall forming the passage 126 to prevent gases from flowing therethrough.

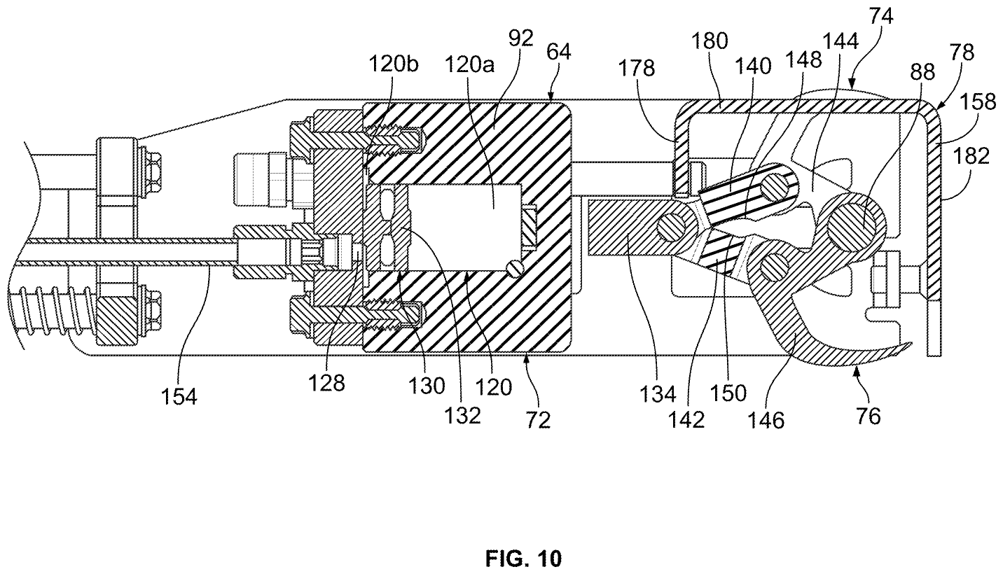

The jaws 74, 76 are pivotally coupled to an end of the piston rod 134. Each jaw 74, 76 has a rear link 140, 142 pivotally coupled to the end of the piston rod 134 at a rear pivot, and curved claw fingers 144, 146 pivotally coupled to the respective rear link 140, 142 at pivots and rotatably coupled to the cylindrical rod 88. The rear links 140, 142 form a V-shape and each rear link 140, 142 has a surface 148, 150, see FIG. 10, on its forward end which is engageable with the cylindrical rod 88.

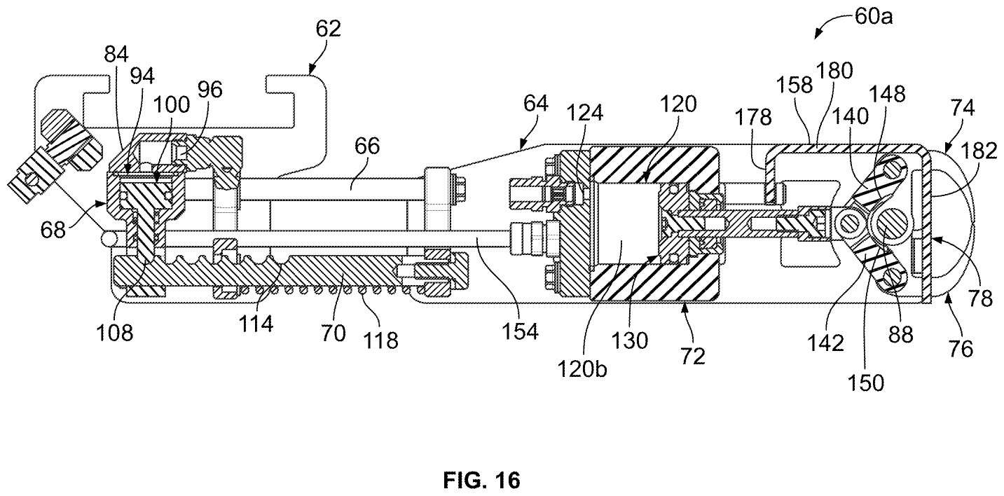

When the front chamber portion 120a is pressurized via gases flowing in from a source (not shown) through the gases passageway 122, the piston rod 134 is in a retracted position, the front ends of the links 140, 142 are spaced apart are at their furthest distance, and the jaws 74, 76 are open such that ends of the curved claw fingers 144, 146 are spaced apart are at their furthest distance as shown in FIG. 10. When the rear chamber portion 120b is pressurized via gases flowing in from a source (not shown) through the gases passageway 124, the pressure in the front chamber portion 120a is overcome and the piston rod 134 moves forward, the links 140, 142 rotate and move the front ends close to each other, and the jaws 74, 76 close such that ends of the curved claw fingers 144, 146 are close to each other and can grip a food product 24 as shown in FIG. 16. The piston assembly 72 thus provides a moving assembly for movement of the jaws 74, 76 to the closed position. The cam surfaces 148, 150 of the links 140, 142 provide a relief to prevent the links 140, 142 from crashing into the cylindrical rod 88. A pneumatic line 154 extends between the gases passageway 128 of the jaw mounting body 64 and the gases passageway 96 of the locking body 62. When the rear chamber portion 120b is pressurized, the upper chamber portion 94a of the pneumatic chamber 94 is pressurized via pneumatic line 154 coupled between the gases passageway 128 and the upper chamber portion 94a of the pneumatic chamber 94, which causes the piston rod 106 to drop into a pocket 114 of the connecting rod 70. As a result, when the jaws 74, 76 close, the position of the connecting rod 70 is also locked into place.

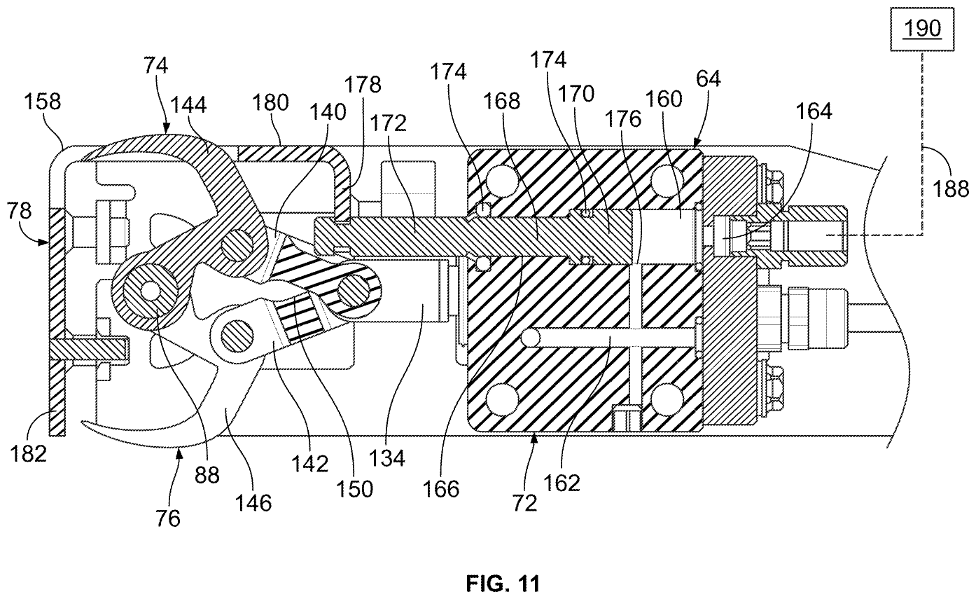

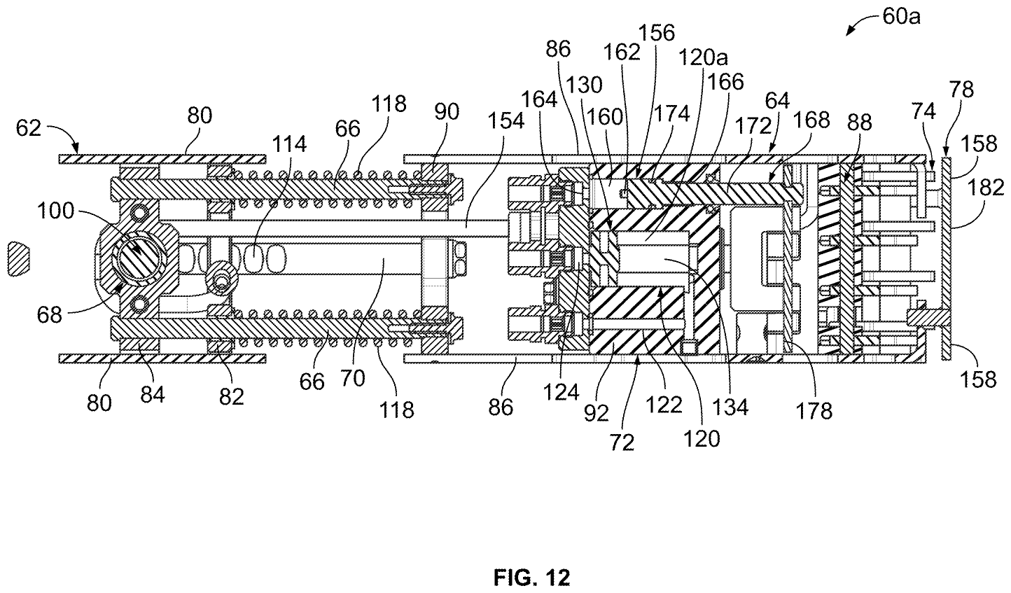

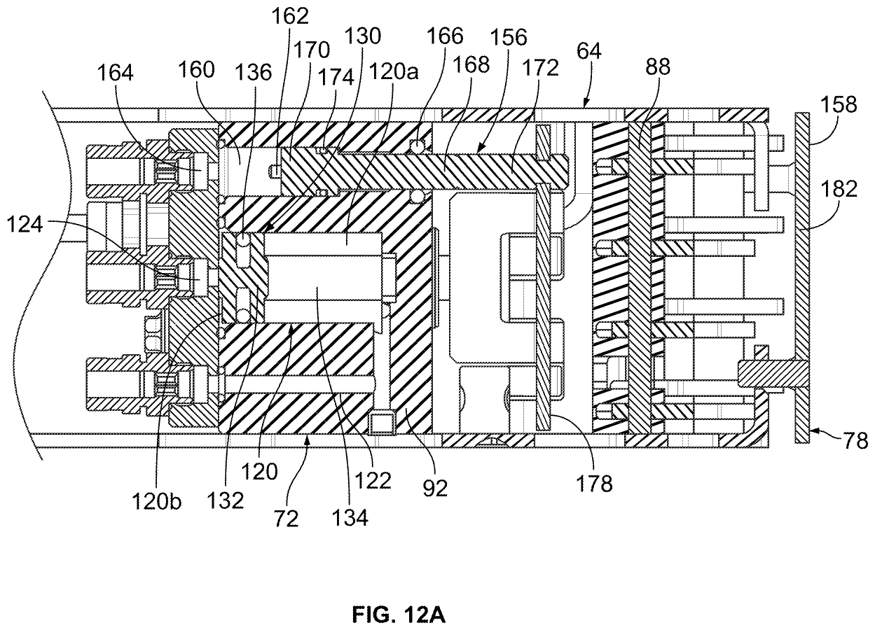

As shown in FIGS. 11-12A, the contact plate assembly 78 includes a piston assembly 156 and a contact plate 158.

The piston assembly 156 includes a pneumatic chamber 160 formed within the intermediate body portion 92, a gases passageway 162 extending between the front chamber portion 120a of the pneumatic chamber 120 of the piston assembly 72 and the pneumatic chamber 160, a gases passageway 164 extending from the exterior of the intermediate body portion 92 and into a rear end of the pneumatic chamber 160, a passage 166 extending from the front end of the pneumatic chamber 120 to the front end of the intermediate body portion 92, and a piston 168 mounted within the pneumatic chamber 160 and the passage 166. The passage 166 has a diameter which is less than the diameter of the pneumatic chamber 160. The pneumatic chamber 160 is in gases communication with the gases passageway 164.

The piston 168 includes an enlarged head 170 and a piston rod 172 extending from a first side of the enlarged head 170. The enlarged head 170 is within the pneumatic chamber 160 and seals 174, such as O-rings, surrounds the head 170 and the piston rod 172 to prevent gases from passing through the passage 166. In some positions of the piston 168, the head 170 of the piston 168 does not overlap an opening 176 of the gases passageway 162 into the pneumatic chamber 160, while in other positions the head 170 of the piston 168 overlaps the opening 176, see FIG. 11, of the gases passageway 162. The piston rod 172 extends through the pneumatic chamber 160 and the passage 166, and further extends outward and forward from the intermediate body portion 92.

The contact plate 158 is affixed to the front end of the piston rod 172 of the piston assembly 156. The contact plate 158 has a vertical rear section 178 which extends from the front end of the piston rod 134, a horizontal section 180 which extends from the upper end of the vertical rear section 178 to a vertical front food product engaging section 182 which extends vertically downward from the front end of the horizontal section 180. The sections 178, 182 are parallel to each other. The sections 180, 182 have openings 184, 186 therethrough through which the curved claw fingers 144 of the upper jaw 74 extends, and the front food product engaging section 182 has lower openings 186 therethrough through which the curved claw fingers 146 of the lower jaw 76 extends. When the jaws 74, 76 are closed, part of the curved claw fingers 144, 146 extend forward of the front food product engaging section 182.

Accordingly, with the jaws 74, 76 open, gases flows from the source and along a gases pathway which includes the gases passageway 122 of the piston assembly 72 the front chamber portion 120a of the pneumatic chamber 120, the gases passageway 162 of the piston assembly 156, the opening 176, the pneumatic chamber 160, and the gases passageway 164 of the piston assembly 156. The gases flows from pneumatic chamber 160 and then into gases passageway 164 and to atmosphere. The gases flowing through gases passageway 164 to atmosphere is less than the pressure amount required in pneumatic chamber 160 to maintain pressure to keep the jaws 74, 76 in the open position.

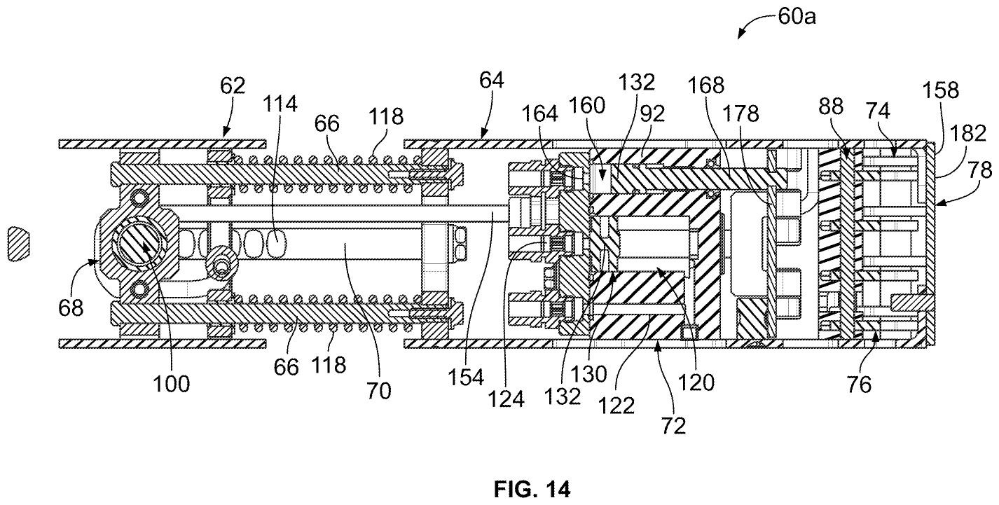

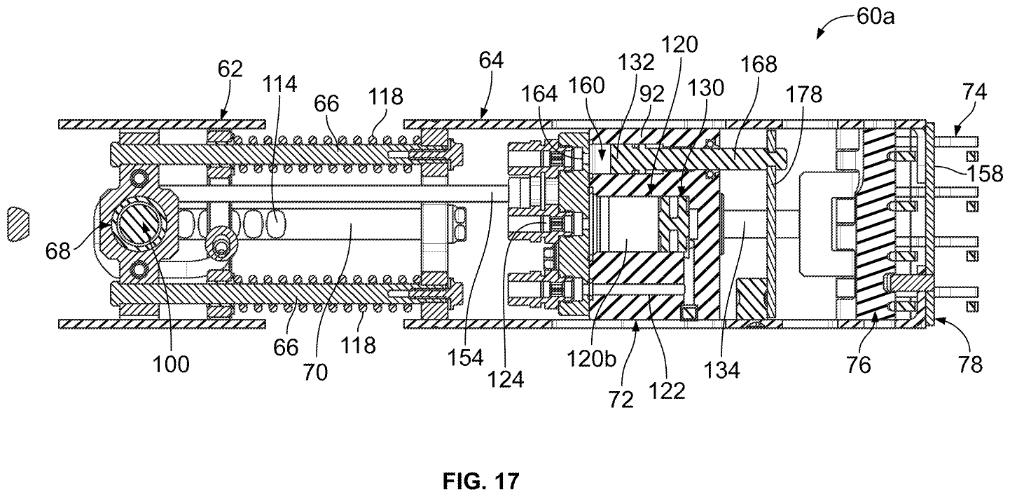

In use, when the front food product engaging section 182 of the contact plate 158 engages with the rear end of a food product 24, the contact plate 158 moves rearward which causes the piston rod 172 to move rearward and the enlarged head 170 to overlap the opening 176 of the gases passageway 162 of the piston assembly 156, see the change in position from FIG. 12 to that shown in FIG. 14. Since the gases passageway 162 of piston assembly 156 is pressurized via the gases passageway 122 of the piston assembly 72 and the front chamber portion 120a of the pneumatic chamber 120, a pressure spike results in gases passageway 164 when the opening 176 of the gases passageway 162 is overlapped by the enlarged head 170 of the piston rod 172. A pneumatic line 188 is coupled to the gases passageway 164 and has a sensor 190 which senses the pressure in the pneumatic line 188, see FIG. 11. The control system 44 is in communication with the sensor 190 and this pressure spike is detected indicating that the contact plate 158 has been moved, which in turn indicates contact with the rear end of the food product 24a. After both grippers 60a, 60b (or 60c, 60d) on the same support rail 56 have contacted the food product 24a, 24b (or 24c, 24d), the control system 44 causes the rear chamber portions 120b to be pressurized via gases flow through gases passageway 124, which causes the pistons 130 to move forward and close the jaws 74, 76 of both grippers 60a, 60b (or 60c, 60d), thereby gripping the rear end of the food product 24a, 24b (or 24c, 24d), see FIGS. 16 and 17. Since the rear chamber portion 120b is pressurized, as described above, the upper chamber portion 94a is pressurized to move the bottom end 108 of the piston rod 106 into the pocket 114 of the connecting rod 70.

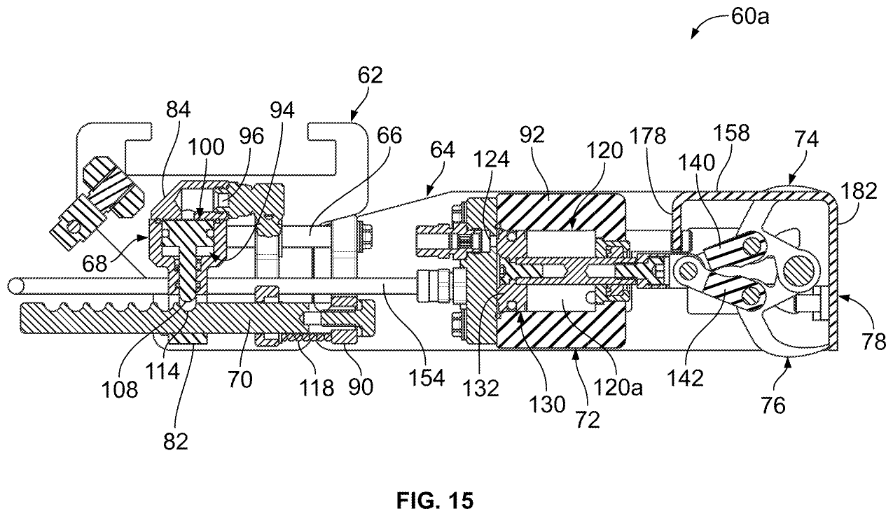

In addition, when only one of the grippers 60a or 60b (60c or 60d) on the same support rail 56 contact the food product 24, the control system 44 does not causes the rear chamber portions 120b to be pressurized. As the support rail 56 continues to move both grippers 60a, 60b (or 60c, 60d) forward, the gripper, for example gripper 60a, in contact with the rear end of the food product 24a, 24b, 24c, 24d collapses onto itself. As shown in FIG. 15, the jaw mounting body 64 and those components mounted thereon, move relative to the locking body 62 and those components mounted thereon. The support rods 66 and the connecting rod 70 slide through the front support plate 82 and the rear body portion 84 of the locking body 62. This causes a different pocket 114 of the connecting rod 70 to be positioned under the bottom end 108 of the piston rod 106. The springs 118 compress between the front support plate 82 of the locking body 62 and the rear support plate 90 of the jaw mounting body 64.

In a second embodiment (not shown), all of the grippers 60a, 60b, 60c, 60d are mounted on the same gripper support rail. While four grippers 60a, 60b, 60c, 60d are shown and described herein, two or more grippers can be provided.

Longitudinal centerline of the grippers 60a-d may be aligned with longitudinal centerlines of the food products 24a, 24b, 24c, 24d.

Now that the specifics of the components of the food product slicing machine 22 have been described, the operation of the food product slicing machine 22 is described with reference to FIGS. 18-27.

Initially, the food product slicing machine 22 is in a load position as shown to facilitate loading of food products 24a, 24b, 24c, 24d onto the tray 30 which is horizontal. The grippers 60a, 60b, 60c, 60d of the gripper assembly 20 are spaced from the upstream end of the upper support assembly 40. The lower surfaces of the food products 24a, 24b, 24c, 24d seat on the tray 30. The product gate 34 is in the up position as shown in FIG. 1.

Once the food products 24a, 24b, 24c, 24d are loaded onto the tray 30 and the tray 30 is moved to the inclined position to align the upper surface thereof with the upper surfaces of the lower support assembly 36, the support rails 56, 58 are moved forward toward the slicing assembly 38 (and if the tray 30 is a conveyor then the conveyor is actuated).

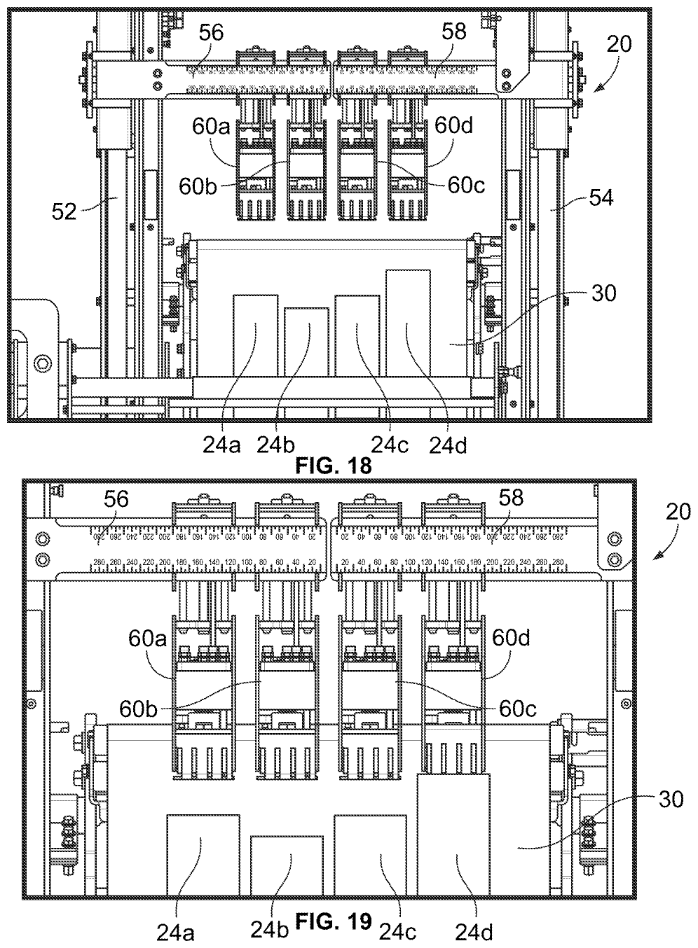

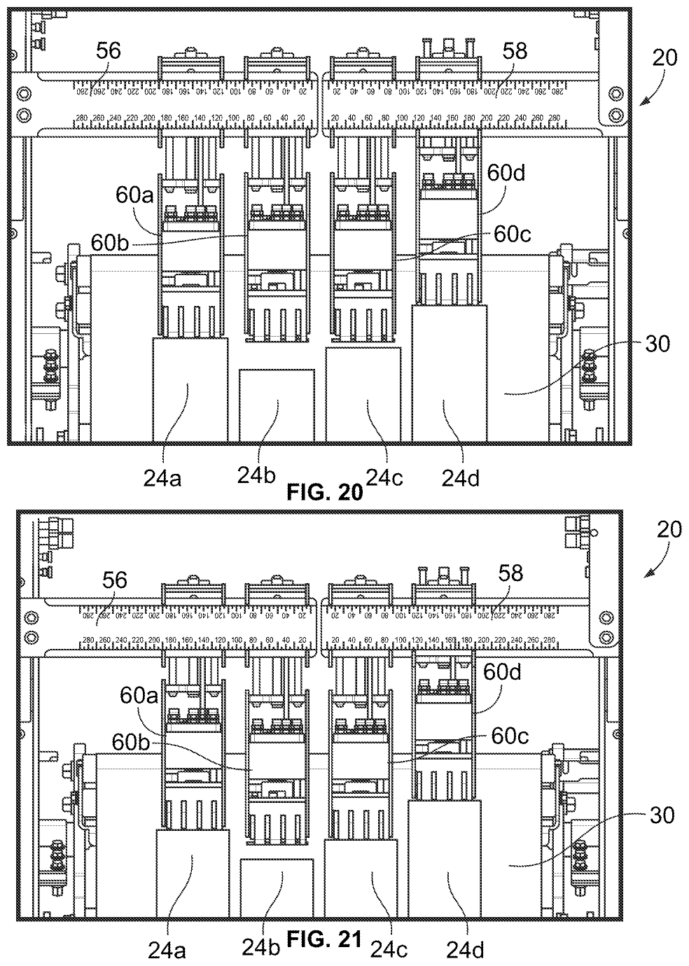

In the example shown in FIGS. 18-27, initially both support rails 56, 58 are moved at the same time. As shown in FIG. 19, the gripper 60d first comes into contact with the rear end of the longest food product 24d. As shown in FIG. 20, the support rails 56, 58 continue to move simultaneously and gripper 60a then comes into contact with the rear end of the next longest food product 24a. Since gripper 60d is already in contact with the food product 24d, gripper 60d starts to collapse and the springs 118 start to compress (springs 118 are not shown in FIGS. 18-27) during this movement from FIG. 19 to FIG. 20.

As shown in FIG. 21, the support rails 56, 58 continue to move simultaneously and gripper 60c then comes into contact with the rear end of the next longest food product 24c. Since gripper 60a and gripper 60d are already in contact with the food product 24d, gripper 60d further collapses and the springs 118 further compress, and the gripper 60a starts to collapse and the springs 118 start to compress.

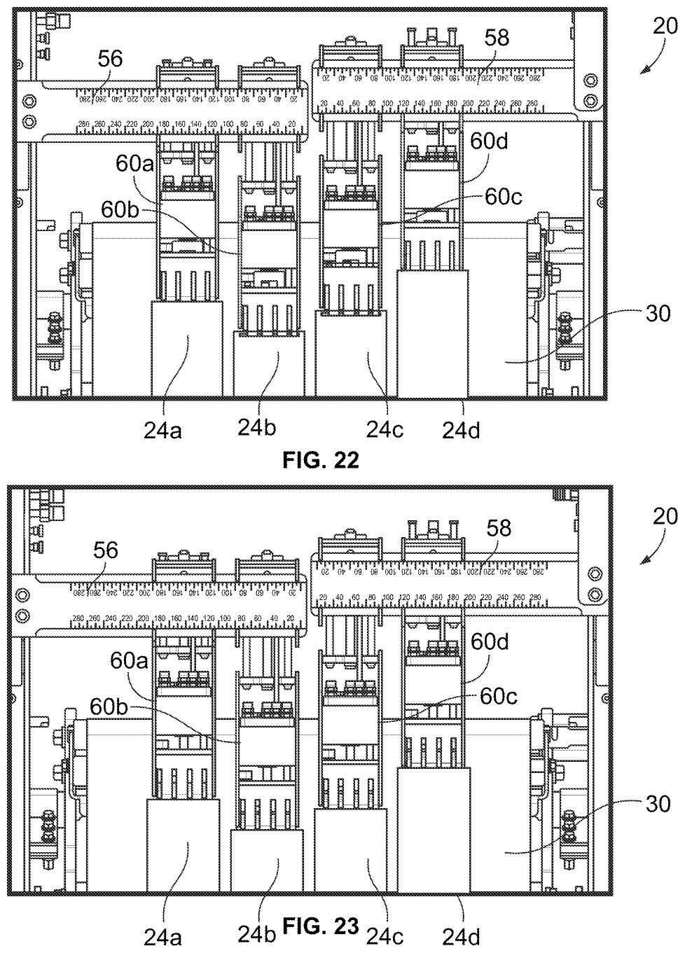

As shown in FIG. 22, support rail 56 continues to move until the gripper 60b comes into contact with the rear end of the shortest food product 24b. Since gripper 60a is already in contact with the food product 24d, gripper 60a further collapses and the springs 118 further compress.

Multiple ones of the grippers 60a, 60b, 60c, 60d may come into simultaneous contact with its food product 24a, 24b, 24c, 24d if the food products 24a, 24b, 24c, 24d have the same length.

As shown in FIG. 23, once all of the grippers 60a, 60b, 60c, 60d are in contact with their food products 24a, 24b, 24c, 24d, the control system 44 causes the jaws 74, 76 of each gripper 60a, 60b, 60c, 60d to close to grip the food products 24a, 24b, 24c, 24d.

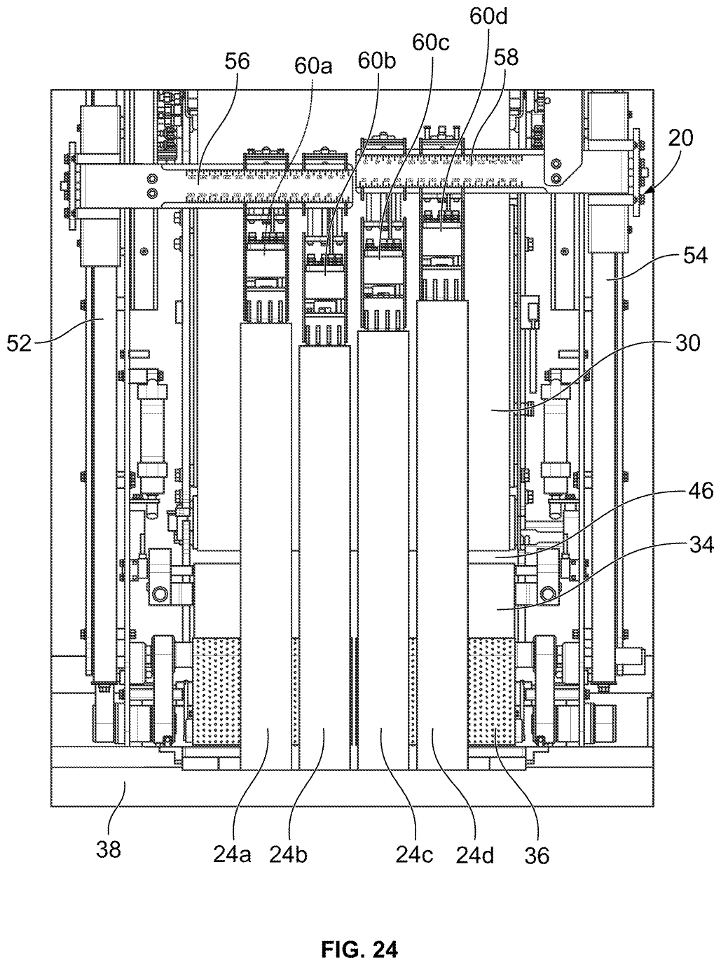

As a result, all of the food products 24a, 24b, 24c, 24d are gripped and the front ends of the food products 24a, 24b, 24c, 24d are aligned with each other against the product gate 34. Next, the product gate 34 is moved to the down position (which may be a pivotal movement), and the support rails 56, 58 are moved which causes the grippers 60a, 60b, 60c, 60d and gripped food products 24a, 24b, 24c, 24d to move over the gap 46 toward the slicing assembly 38, see FIG. 24. When in the down position, the upper surface of the stop product gate 34 aligns with the planar upper surfaces of the tray 30 and aligns with the planar upper surfaces of the lower support assembly 36. The food products 24a, 24b, 24c, 24d pass over the gap 46 and move onto the lower support assembly 36 while continuously being gripped by the grippers 60a, 60b, 60c, 60d. The grippers 60a, 60b, 60c, 60d move the food products 24a, 24b, 24c, 24d into and through the slicing assembly 38. If the lower support assembly 36 is a conveyor, it is activated, and if the upper support assembly 38 is provided, it is activated.

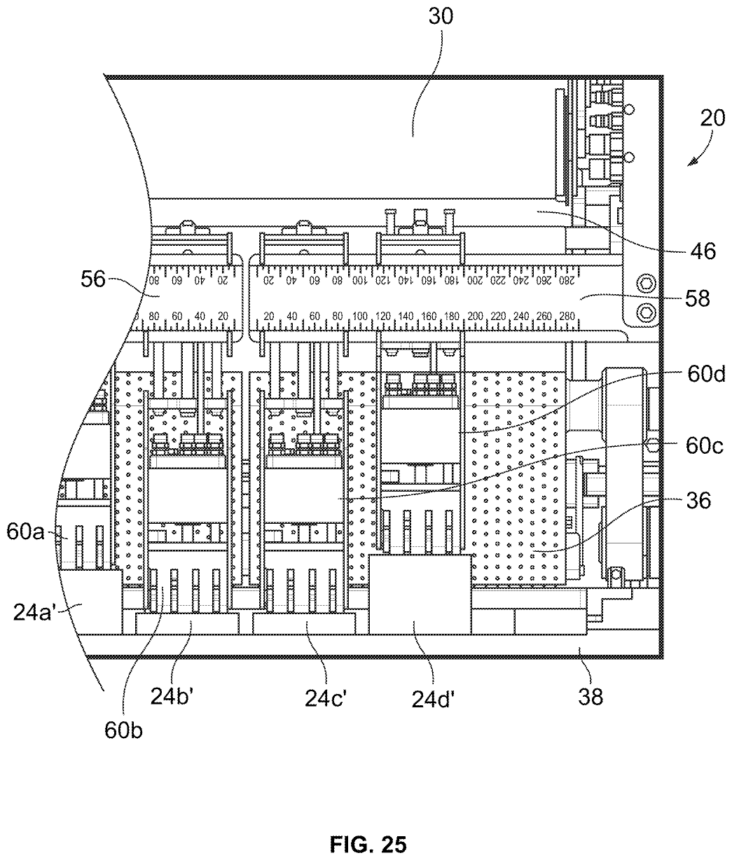

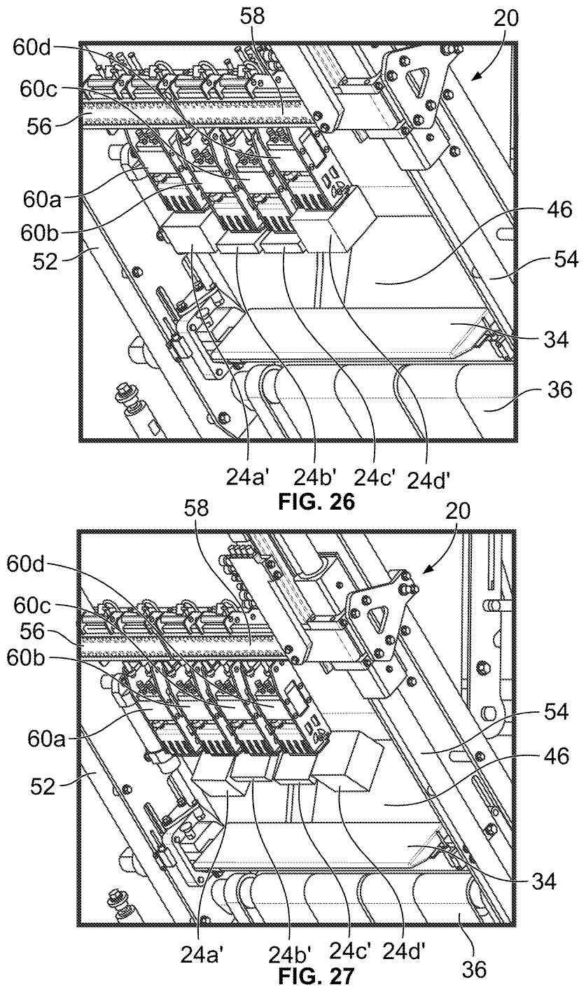

The support rails 56, 58 are continued to be moved to cause the grippers 60a, 60b, 60c, 60d and gripped food products 24a, 24b, 24c, 24d through the slicing assembly 38 until the travel length of the support rails 56, 58 along the side rails 52, 54 is not further possible. As shown in FIG. 25, a butt end 24a′, 24b′, 24c′, 24d′ of each food product 24a, 24b, 24c, 24d is what remains on the lower support assembly 36 and is still gripped by the grippers 60a, 60b, 60c, 60d. Thereafter, the motion of the grippers 60a, 60b, 60c, 60d is reversed and the butt ends 24a′, 24b′, 24c′, 24d′ are slid back over the product gate 34 until the butt ends 24a′, 24b′, 24c′, 24d′ align with the gap 46 as shown in FIG. 26 (the tray 30 is removed so that the grippers 60a, 60b, 60c, 60d and the butt ends 24a′, 24b′, 24c′, 24d′ can be seen). Thereafter, the jaws 74, 76 of each gripper 60a, 60b, 60c, 60d are opened to allow the butt ends 24a′, 24b′, 24c′, 24d′ to fall through the gap 46 as shown in FIG. 27. The jaws 74, 76 of each gripper 60a, 60b, 60c, 60d are opened by pressuring the front chamber portion 120a and relieving pressurization of the rear chamber portion 120b. Pressurization of the front chamber portion 120a causes gases flow around the enlarged head 170 of the piston 168 which causes the piston 168 to move and extend outward from the intermediate body portion 92 which in turn causes the contact plate 158 to move to its initial position. Relieving pressurization of the rear chamber portion 120b relieves pressure in the gases passageway 96 and the pneumatic chamber 94, and the return spring 102 surrounding the piston 100 causes the bottom end 108 to move out of the pocket 114 of the connecting rod 70. The springs 118 then expand and move the jaw mounting body 64 and those components mounted thereon relative to the locking body 62 and those components mounted thereon.

After the butt ends 24a′, 24b′, 24c′, 24d′ are released through the gap 46, the grippers 60a, 60b, 60c, 60d are retracted to their initial positions and are ready to accept new food products 24a, 24b, 24c, 24d.

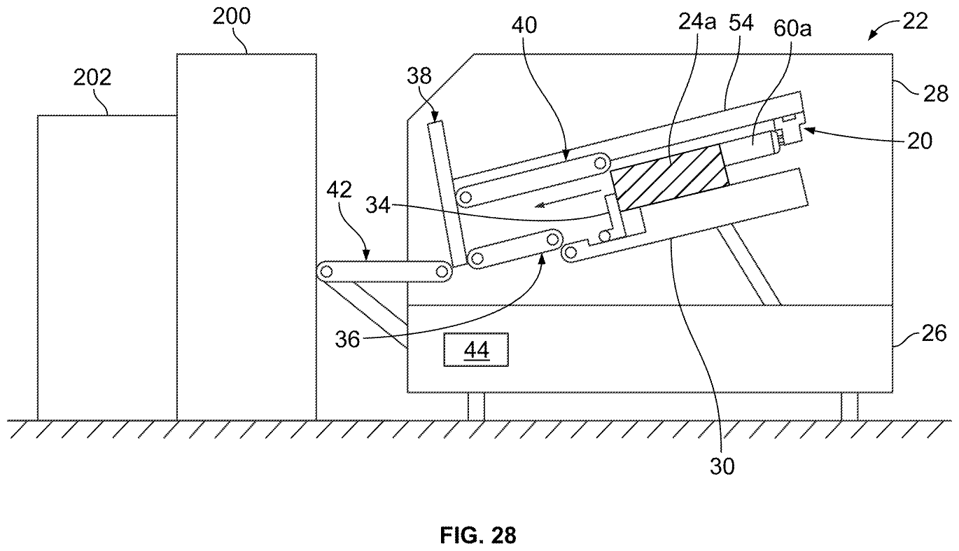

The food product slicing machine 22 may form part of a line of food processing equipment which contains other pieces of equipment, such as for example, a conventional packaging assembly 200 (shown schematically), a conventional labeling assembly 202 (shown schematically), etc., see FIG. 28.

While a particular embodiment is illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiment illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

1. A gripper for gripping a rear end of a food product comprising:
a jaw mounting body having a pneumatic pathway therethrough;
a pair of jaws pivotally mounted on the jaw mounting body;
a moving assembly which is configured to move the pair of jaws from an open position to a closed position;
a controller; and
a contact plate assembly which provides information regarding a pressure spike in the pneumatic pathway to the controller that contact with the rear end of the food product has occurred.

2. The gripper of claim 1, wherein the contact plate assembly includes
a first pneumatic chamber within the jaw mounting body which forms part of the pneumatic pathway,
a first piston having a first enlarged head seated within the first pneumatic chamber and a first piston rod extending from a first side of the first enlarged head and outward from the jaw mounting body,
a first gases passageway within the jaw mounting body and which provides gases into the first pneumatic chamber through an opening into the first pneumatic chamber and which forms part of the pneumatic pathway; and
a contact plate coupled to the first piston rod forward of the jaw mounting body, wherein movement of the contact plate causes the first enlarged head of the first piston rod to overlap the opening thereby causing the pressure spike within the first pneumatic chamber.

3. The gripper of claim 2, in combination with a food product slicing machine, the food product slicing machine comprising:
a frame;
a support rail movably mounted on the frame, the gripper being mounted on the support rail;
a tray mounted on the frame and configured to support food product; and
a slicing assembly which cuts the food product into slices.

4. The combination of claim 3, wherein the food product slicing machine is part of a line of food processing equipment.

5. The combination of claim 3, wherein the food product slicing machine further comprises a product gate assembly mounted on the frame and configured to support front ends of the food products, wherein the product gate assembly is movable from a position in which front ends of the food products engage to a position which is not in contact with the front ends of the food products.

6. The gripper of claim 3, wherein a second gripper is provided on the support rail.

7. The gripper of claim 3, wherein a pair of support rails are provided and each support rail supports at least two grippers.

8. The gripper of claim 4, wherein the contact plate assembly further includes a pressure sensor configured to sense the pressure spike.

9. The gripper of claim 8, wherein the controller is configured to receive information from the pressure sensor and thereafter activate the moving assembly to move the jaws to the closed position.

10. The gripper of claim 9, wherein the moving assembly comprises:
a second pneumatic chamber within the jaw mounting body and which forms part of the pneumatic pathway, and
a second piston having a second enlarged head seated within the second pneumatic chamber and a second piston rod extending from a first side of the second enlarged head and outward from the jaw mounting body, the second piston rod of the second piston being coupled to the jaws.

11. The gripper of claim 10, wherein the gripper further includes a second gases passageway in the jaw mounting body which provides gases into the second pneumatic chamber on a second side of the enlarged head of the second piston and which forms part of the pneumatic pathway, and wherein the second pneumatic chamber provides gases into the first gases passageway from the second gases passageway.

12. The gripper of claim 11, wherein the gripper further comprising:
a third gases passageway in the jaw mounting body which provides gases into the second pneumatic chamber on a second side of the enlarged head of the second piston;
a connecting rod fixedly extending from a rear end of the jaw mounting body, the connecting rod having a plurality of pockets therein;
a locking body fixedly coupled to the support rail, the locking body having a third pneumatic chamber therein; and
a third piston having a third enlarged head seated within the third pneumatic chamber and a third piston rod extending from a first side of the third enlarged head and outward from the locking body, wherein the third gases passageway provides gases to the third pneumatic chamber on a second side of the third enlarged head, wherein the connecting rod is slidable relative to locking body, and wherein an end of the third piston rod seats within one of the pockets upon actuation of the third piston.

13. The gripper of claim 12, in combination with a food product slicing machine, the food product slicing machine comprising:
a frame;
a support rail movably mounted on the frame, the gripper being mounted on the support rail;
a tray mounted on the frame and configured to support food product; and
a slicing assembly which cuts the food product into slices.

14. The combination of claim 13, wherein the food product slicing machine is part of a line of food processing equipment.

15. The combination of claim 13, wherein the food product slicing machine further comprises a product gate assembly mounted on the frame and configured to support front ends of the food products, wherein the product gate assembly is movable from a position in which front ends of the food products engage to a position which is not in contact with the front ends of the food products.

16. The gripper of claim 13, wherein a second gripper is provided on the support rail.

17. The gripper of claim 13, wherein a pair of support rails are provided and each support rail supports at least two grippers.

18. The gripper of claim 12, further comprising at least one support rod fixedly extending from a rear end of the jaw mounting body, and the locking body being mounted on the at least one support rod and slidable thereon.

19. The gripper of claim 18, further comprising a spring surrounding the at least one support rod and being compressible between the jaw mounting body and the locking body.

20. The gripper of claim 1, in combination with a food product slicing machine, the food product slicing machine comprising:
a frame;
a support rail movably mounted on the frame, the gripper being mounted on the support rail;
a tray mounted on the frame and configured to support food product; and
a slicing assembly which cuts the food product into slices.

21. The combination of claim 20, wherein the food product slicing machine is part of a line of food processing equipment.

22. The combination of claim 21, wherein the food product slicing machine further comprises a product gate assembly mounted on the frame and configured to support front ends of the food products, wherein the product gate assembly is movable from a position in which front ends of the food products engage to a position which is not in contact with the front ends of the food products.

23. The gripper of claim 22, wherein a second gripper is provided on the support rail.

24. The gripper of claim 23, wherein a pair of support rails are provided and each support rail supports at least two grippers.

25. A method of slicing food products comprising:
moving at least one support rail having a plurality of grippers mounted thereon, each gripper having jaws thereon;
engaging a rear end of a first food product with a first one of the grippers thereby causing a pressure spike in a pneumatic line of the first one of the grippers;
continuing movement of the at least one support rail until a second one of the grippers engages a rear end of a second food product, wherein the first one of the grippers collapses on itself during this movement and a pressure spike in a pneumatic line of the second one of the grippers occurs;
closing the jaws of both grippers to engage the rear ends of the food product;
continuing movement of the at least one support rail; and
slicing front ends of the food products.

26. The method of claim 25, wherein front ends of the food products are engaged against a product gate, and wherein prior to movement of the at least one support rail, the product gate is moved out of engagement with the front ends of the food products.

27. The method of claim 25, further comprising dropping butt ends of the food products through an opening by opening the jaws of the grippers.

28. The method of claim 25, wherein the first one of the grippers is on a first support rail and the second one of the grippers is on a second support rail, wherein movement of the first support rail is stopped until the jaws on both grippers are closed.
